(19) United States
(12) Patent Application Publication
(10) Pub. No.: US 2014/0141662 A1
(43) Pub. Date: May 22, 2014

(54) TERMINAL FOR WATERPROOF CONNECTOR

(71) Applicant: YAZAKI CORPORATION, Tokyo (JP)

(72) Inventor: Yoji KUTSUNA, Makinohara-shi (JP)

(73) Assignee: YAZAKI CORPORATION, Tokyo (JP)

(21) Appl. No.: 14/162,867

(22) Filed: Jan. 24, 2014

Related U.S. Application Data
(63) Continuation of application No. PCT/JP2012/069529, filed on Jul. 25, 2012.

(30) Foreign Application Priority Data
Jul. 25, 2011 (JP) 2011-162468

(51) Int. Cl. H01R 13/11

(52) U.S. Cl. CPC H01R 13/11
USPC 439/888

(57) ABSTRACT

A terminal for a waterproof connector to be inserted through a waterproof plug is provided. A fitting tube part of the terminal has a square tube shape and includes first to third walls. The first wall has a side extending in a longitudinal direction of the terminal. The second wall is extended from the side in orthogonal to the first wall, and has a side edge extending in the longitudinal direction at opposite side with respect to the first wall. The third wall opposes the first wall, and has a side edge extending in the longitudinal direction and contacting the side edge of the second wall. An engaging piece is extended from the side edge of the third wall in orthogonal to the third wall so as to overlap the second wall. The second wall is formed with a concave portion accommodating the engaging piece.

### CROSS REFERENCE TO RELATED APPLICATIONS

This application is a continuation of PCT application No. PCT/JP2012/069529, which was filed on Jul. 25, 2012 based on Japanese Patent Application (No. 2011-162468) filed on Jul. 25, 2011, the contents of which are incorporated herein by reference.

### BACKGROUND OF THE INVENTION

1. Field of the Invention

The present invention is related to a terminal for a waterproof connector, which is inserted into a waterproof plug attached to the waterproof connector.

2. Description of the Related Art

FIG. 5 shows a waterproof connector 110 disclosed in below-described PTL 1.

The waterproof connector 110 has a waterproof plug 120 provided in a base end side of a terminal insert hole 112 formed in a resin housing 111.

The waterproof plug 120 is fitted to a terminal 130 for the waterproof connector inserted into and attached to the terminal insert hole 112 from a fitting tube part 131 side to prevent rainwater from entering the resin housing 111 through an electric wire 140 connected to the terminal 130 for the waterproof connector.

The terminal 130 for the waterproof connector is a female terminal formed by a press forming of a metal plate, and includes the fitting tube part 131 to which a male terminal of a mate is fitted and an electric wire connecting part 132 which is formed integrally with a rear end of the fitting tube part 131 and to which the electric wire 140 is connected.

The fitting tube part 131 is formed in a square tube structure to which a terminal fitting of the mate is fitted by a bending work of a metal plate.

When the fitting tube part 131 is formed, as shown in FIG. 6, side edges of side walls 341 and 144 of four side walls 341, 342, 143 and 144 of right, left, upper and lower surfaces forming the square tube structure which are both ends in an expanded state are butted against each other.

In FIG. 6, the one side wall 341 of the one pair of side walls 341 and 144 whose side edges are butted against each other is a right side wall in the fitting tube part 131 and the other side wall 144 is an upper side wall in the fitting tube part 131.

In the case of the terminal 130 for the waterproof connector shown in FIG. 5 and FIG. 6, in order to prevent the side walls 341 and 144 whose side edges are butted against each other from opening due to a spring back of the side walls 341 and 144, an engaging piece 145 formed in the one side wall 341 of the one pair of side walls 341 and 144 butted against each other is folded on the other side wall 144.

In the case of the terminal 130 for the waterproof connector shown in FIG. 5 and FIG. 6, the engaging piece 145 protrudes from an outer surface of the other side wall 144.

FIG. 7 and FIG. 8 show a terminal 230 for a waterproof connector disclosed in below-described PTL 2.

The terminal 230 for the waterproof connector is also a female terminal formed by a press forming of a metal plate and inserted into a waterproof plug from a fitting tube part 231 side having a square tube structure similarly to the terminal 130 for the waterproof connector shown in FIG. 5.

In the fitting tube part 231 disclosed in the PTL 2, a right side wall 241, a lower side wall 242, a left side wall 243 and an upper side wall 244 form four side walls of the square tube structure. In the case of the fitting tube part 231, in the right side wall 241, an engaging plate part 245 laminated on a lower surface of the upper side wall 244 is extended.

In the engaging plate part 245, an engaging piece 246 protruding in a side edge of the left side wall 243 is fitted to an engaging hole 251 which is formed so as to pass through the left side wall 243, so that the engaging plate part 245 is connected to the left side wall 243. Then, the engaging piece 246 is fitted to the engaging hole 251 to connect the engaging plate part 245 to the left side wall 243. Thus, the fitting tube part 231 is prevented from opening.

### CITATION LIST

### Patent Literature

[PTL 1] JP-A-2008-4471

[PTL 2] JP-8-7964

### SUMMARY OF THE INVENTION

In the structure that the engaging piece 145 for preventing the fitting tube part 131 from opening protrudes on the outer surface of the fitting tube part 131 as in the terminal 130 for the waterproof connector disclosed in the PTL 1, when the terminal 130 for the waterproof connector is inserted into the waterproof plug, the engaging piece 145 may scratch an inner surface of the waterproof plug to damage the waterproof plug. Then, a waterproofing property by the waterproof plug may be deteriorated due to the damage of the waterproof plug.

On the other hand, in the structure using an operation that the engaging piece 246 is fitted to the engaging hole 251 in order to prevent the fitting tube part 231 from opening as in the terminal 230 for the water proof connector disclosed in the PTL 2, since the engaging piece 246 does not protrude to the outer surface, the waterproof plug can be prevented from being damaged. However, in the structure of the terminal 230 for the waterproof connector disclosed in the PTL 2, as compared with the structure that the engaging piece 145 is simply folded on the adjacent side wall, a high working accuracy is required, so that a production cost may be increased to improve the working accuracy.

It is therefore one advantageous aspect of the present invention to provide a terminal for a waterproof connector in which it is prevented to damage a waterproof plug and to deteriorate a waterproofing property when the terminal is inserted into the waterproof plug, and a production cost is reduced due to mitigate a working accuracy.

According to one advantage of the invention, there is provided a terminal for a waterproof connector, configured to be inserted through a waterproof plug attached in the waterproof connector, the terminal comprising:

a fitting tube part, having a square tube shape, and including:
a first wall having a side extending in a longitudinal direction of the terminal;
a second wall, extended from the side of the first wall in orthogonal to the first wall, and having a side edge extending in the longitudinal direction at opposite side with respect to the first wall; and
a third wall, opposing the first wall, and having a side edge extending in the longitudinal direction and contacting the side edge of the second wall; and

a wire connection part, provided at an end of the fitting tube part in the longitudinal direction, and configured to be connected with a wire,

wherein an engaging piece is extended from the side edge of the third wall in orthogonal to the third wall so as to overlap the second wall, and

wherein the second wall is formed with a concave portion accommodating the engaging piece.

The terminal for the waterproof connector may be configured such that: the second wall includes an outer layer and an inner layer overlapping the outer layer; the outer layer is extended from the side of the first wall, and includes a notch portion at a position corresponding to the engaging piece; and the inner layer is extended from the side edge of the second wall in a folded manner, and includes an outer surface at the position corresponding to the engaging piece so that the concave portion is defined by the notch portion and the outer surface.

The concave portion may have a depth larger than a thickness of the engaging piece so that the engaging piece is not projected from the second wall outward.

The fitting tube part and the engaging piece may be made by bending a plate member.

In the terminal for the waterproof connector according to the present invention, in order to prevent the fitting tube part from opening, the engaging pieces protruding in the third wall and folded on the second wall are accommodated in the concave portions provided in the second wall and do not protrude outside from the second wall. Accordingly, when the terminal for the waterproof connector is inserted into the waterproof plug, the engaging pieces do not damage the waterproof plug, so that the waterproofing property is not deteriorated.

Further, since the engaging pieces which prevent the fitting tube part from opening are simply folded on the adjacent walls by the simple work, the high working accuracy is not required. Accordingly, the production cost can be reduced by mitigating the working accuracy.

Further, the second wall has a two-layered structure that the inner layer material is laminated on the back surface of the outer layer material. Thus, when the ranges of the outer layer material providing the outer surface which are overlapped on the engaging pieces are cut out, the concave portions in which the engaging pieces are accommodated can be simply ensured. Thus, a formational property of the fitting tube part can be improved.

### BRIEF DESCRIPTION OF THE DRAWINGS

FIG. 1 is a perspective view of embodiment of a terminal for a waterproof connector according to an embodiment of the present invention.

FIG. 2 is a longitudinally sectional view of the terminal for the waterproof connector shown in FIG. 1.

FIG. 3 is a development view of the terminal for the waterproof connector shown in FIG. 1.

FIG. 4 is a perspective view of a concave portion on which an engaging piece shown in FIG. 1 is folded.

FIG. 5 is an explanatory view of a conventional terminal for a waterproof connector and a waterproof connector.

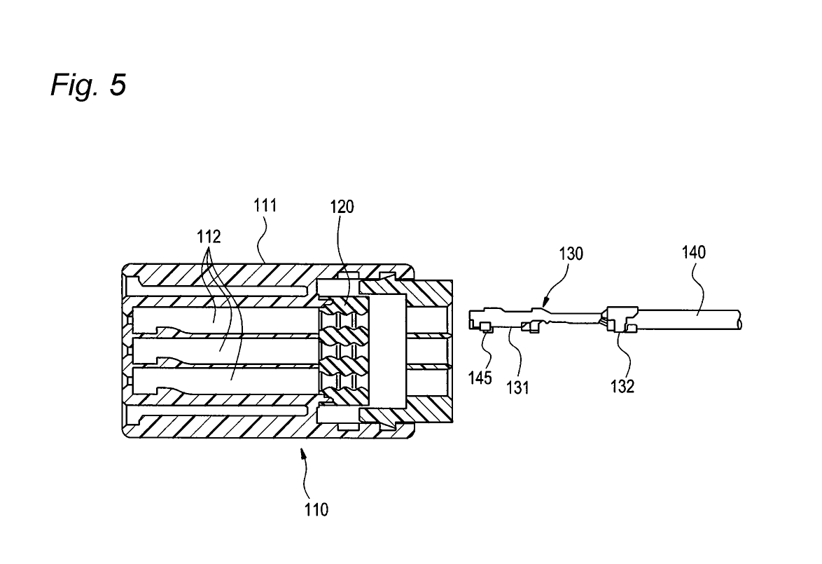

FIG. 6 is an explanatory view of an opening preventing structure in the terminal for the waterproof connector shown in FIG. 5.

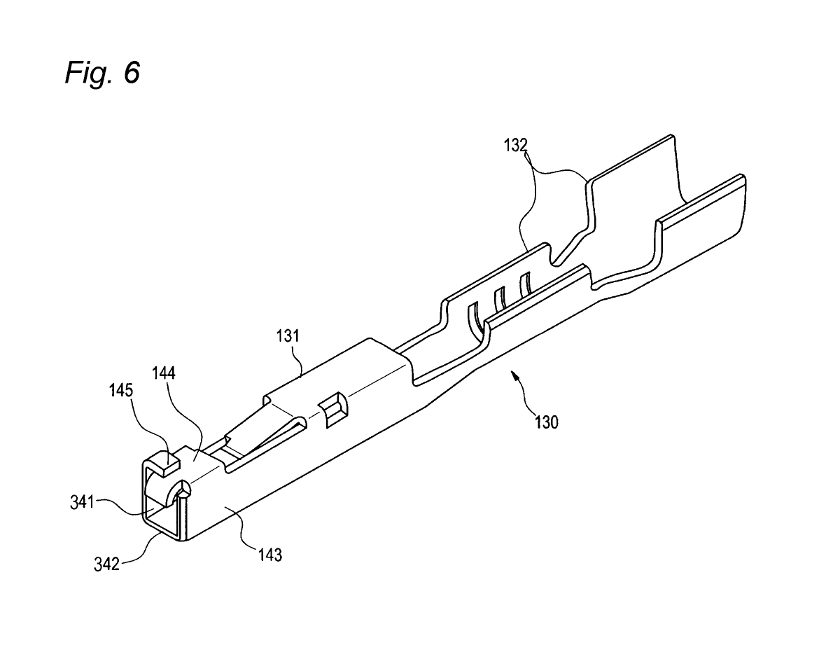

FIG. 7 is a perspective view of another conventional terminal for a waterproof connector.

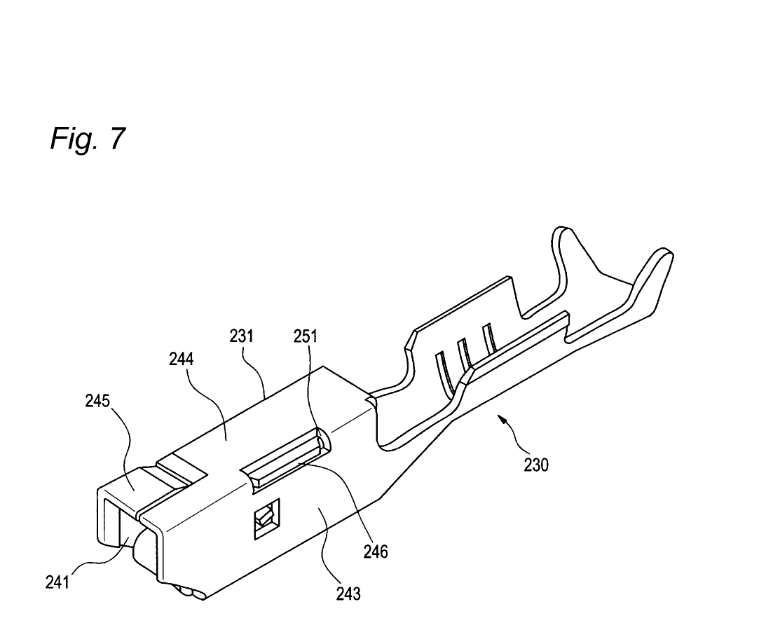

FIG. 8 is a longitudinally sectional view of the terminal for the waterproof connector shown in FIG. 7.

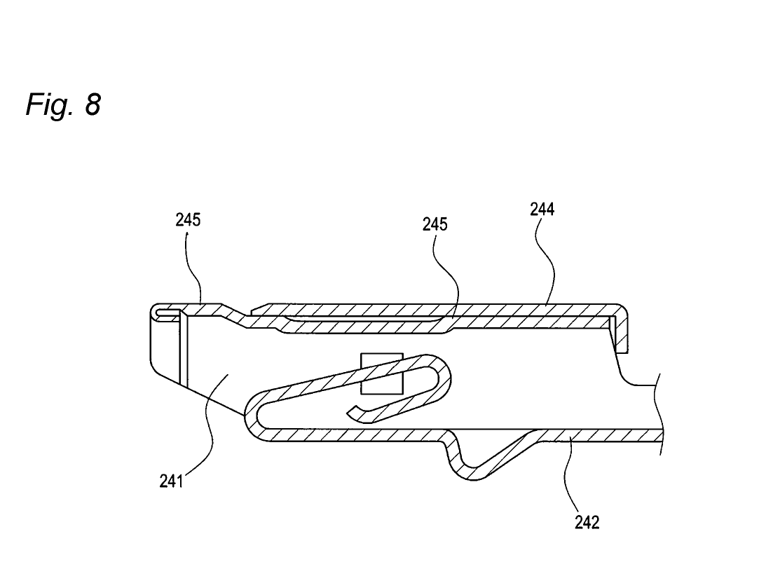

### DETAILED DESCRIPTION OF THE EXEMPLARY EMBODIMENTS

An embodiment of a terminal for a waterproof connector according to the present invention will be described below in detail by referring to the drawings.

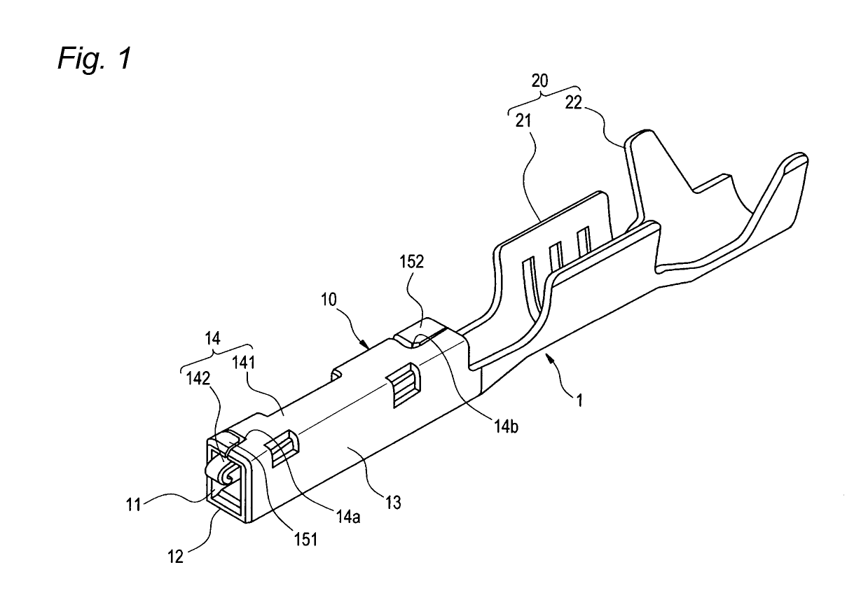

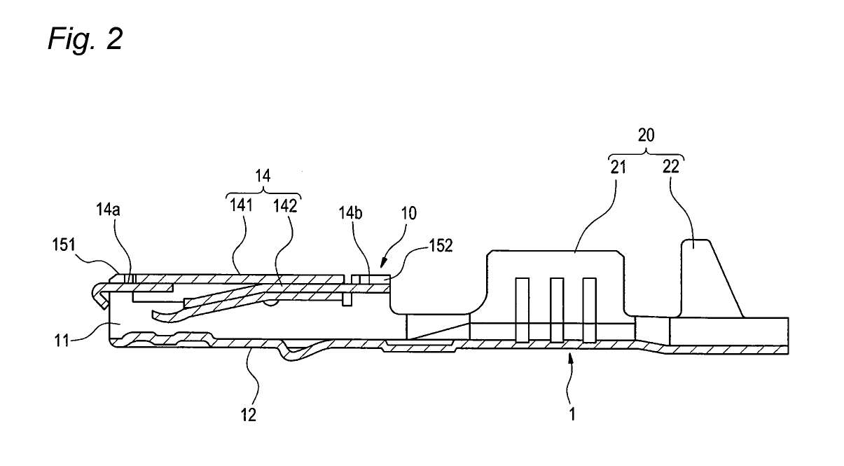

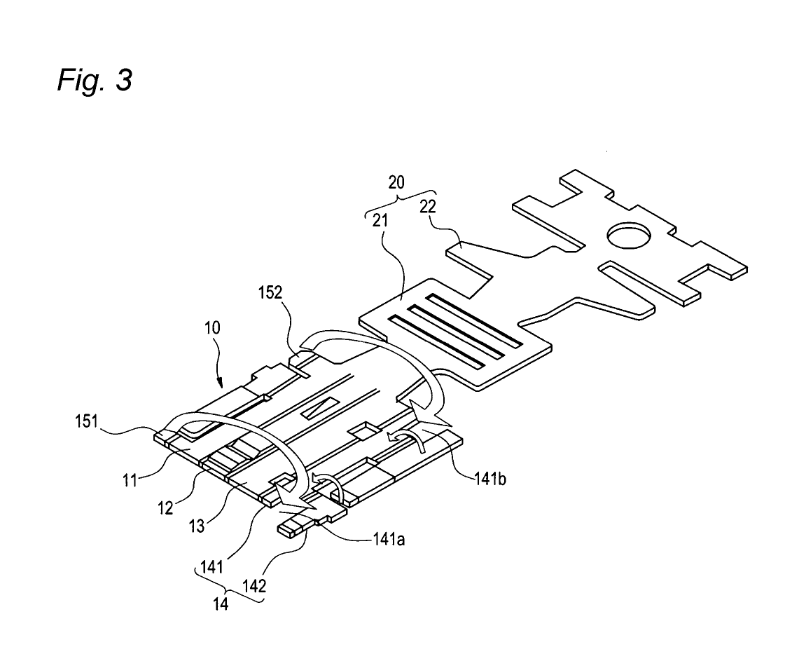

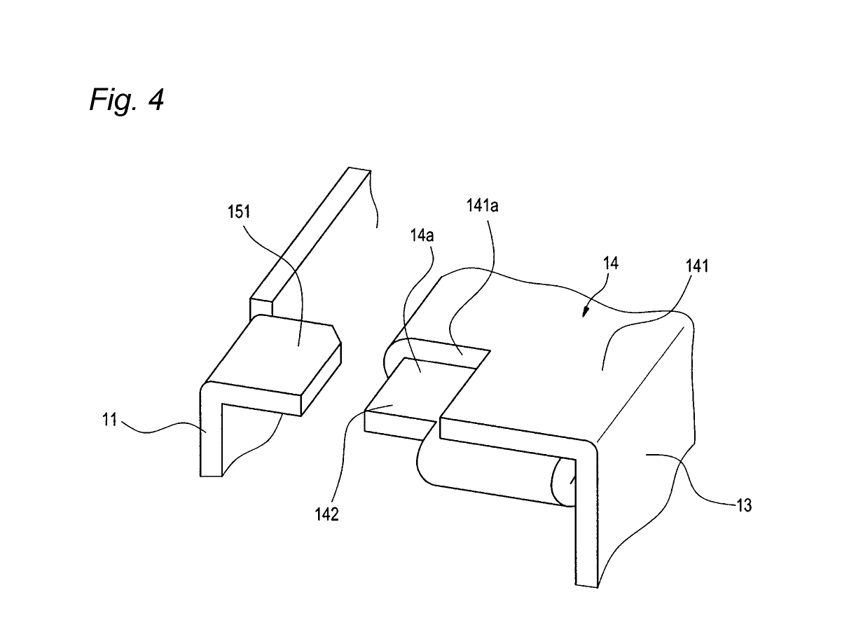

FIG. 1 to FIG. 4 are explanatory views of one embodiment of a terminal for a waterproof connector according to the present invention. FIG. 1 is a perspective view of the terminal for the waterproof connector of the one embodiment. FIG. 2 is a longitudinally sectional view of the terminal for the waterproof connector shown in FIG. 1. FIG. 3 is a development view of the terminal for the waterproof connector shown in FIG. 1. FIG. 4 is a perspective view of a concave portion on which an engaging piece shown in FIG. 1 is folded.

The terminal 1 for the waterproof connector of the one embodiment is a female terminal formed by a press forming of a metal plate (a plate member), and includes a fitting tube part 10 to which a male terminal of a mate is fitted and an electric wire connecting part 20 (a wire connection part) which is formed integrally with a rear end of the fitting tube part 10 and to which an electric wire is crimped.

The fitting tube part 10 is formed in a square tube structure to which a terminal fitting of the mate is fitted by a bending work of the metal plate. The electric wire connecting part 20 includes, as shown in FIG. 1 and FIG. 2, a conductor crimping piece 21 crimped to a conductor of an electric wire and a coat crimping piece 22 crimped on an outer jacket of the electric wire to fix the electric wire.

In the fitting tube part 10, as shown in FIG. 3, plate members as side walls 11, 12, 13 and 14 of four surfaces in right, left, upper and lower parts which form the square tube structure are arranged in order in an expanded state.

In the case of the present embodiment, the side wall 11 (a third wall) becomes the side wall of the right part when the square tube structure is formed. Further, the side wall 12 becomes the side wall of the lower part when the square tube structure is formed. The side wall 13 (a first wall) becomes the side wall of the left part when the square tube structure is formed. The side wall 14 (a second wall) becomes the side wall of the upper part when the square tube structure is formed.

When the side walls 11, 12, 13 and 14 of the four surfaces in the expanded state as shown in FIG. 3 are formed in the square tube structure by the bending work, side edges of the side walls 11 and 14 at both ends in the expanded state are butted against each other.

In the one side wall 11 as the right side wall of the one pair of side walls 11 and 14 whose side edges are butted against each other, engaging pieces 151 and 152 protrude.

The engaging pieces 151 and 152 are provided in a front end side and a rear end side of the fitting tube part 10. The engaging pieces 151 and 152 protruding in the side wall 11 are folded on the other side wall 14 in order to prevent the side walls 11 and 14 from opening.

The other side wall 14 of the one pair of side walls 11 and 14 whose side edges are butted against each other includes an outer layer material 141 and an inner layer material 142 as shown in FIG. 3.

The outer layer material 141 is extended from a side edge of the left side wall 13 opposed to the one side wall 11 when the square tube structure is formed to provide an outer surface of the other side wall 14.

The inner layer material 142 is extended from the outer layer material 141 and folded on a back surface of the outer layer material 141 to form the other side wall 14 in which the plate materials are laminated in a two-layered structure.

In the present embodiment, in the outer layer material 141, are formed cut-out parts (notch portions) 141a and 142b in which ranges overlapped on the engaging pieces 151 and 152 are cut out as shown in FIG. 3. When the side walls 11, 12, 13 and 14 of the four surfaces are formed in the tubular structure, since the cut-out parts 141a and 142a are formed, the inner layer material 142 folded on the back of the outer layer material 141 is exposed as shown in FIG. 4 and concave portions 14a and 14b are formed which are recessed by one step from the outer layer material 141.

When the side walls 11, 12, 13 and 14 of the four surfaces are respectively formed in the tubular structure and the engaging pieces 151 and 152 are folded on the other side wall 14, the engaging pieces 151 and 152 are accommodated in the concave portions 14a and 14b not so as to protrude outside the outer surface of the other side wall 14 as shown in FIG. 1 and FIG. 2. Specifically, the concave portions 14a and 14b have a depth larger than a thickness of the engaging pieces 151 and 152 so that the engaging pieces 151 and 152 are not projected from the side wall 14 outward.

The above-described terminal 1 for the waterproof connector of the one embodiment is inserted into a waterproof plug attached to the waterproof connector from the fitting tube part 10 side.

In the above-described terminal 1 for the waterproof connector of the one embodiment, in order to prevent the fitting tube part 10 from opening, the engaging pieces 151 and 152 protruding in one side wall 11 and folded on the other side wall 14 are accommodated in the concave portions 14a and 14b provided in the other side wall 14 and do not protrude outside from the other side wall 14.

Accordingly, when the terminal 1 for the waterproof connector is inserted into the waterproof plug, the engaging pieces 151 and 152 do not damage the waterproof plug, so that a waterproofing property is not deteriorated.

Further, since the engaging pieces 151 and 152 which prevent the fitting tube part 10 from opening are simply folded on the adjacent side walls 11, 12, 13 and 14 by a simple work, a high working accuracy is not required. Accordingly, a production cost can be reduced by mitigating the working accuracy.

Further, in the case of the terminal 1 for the waterproof connector of the above-described one embodiment, the other side wall 14 has the two-layered structure that the inner layer material 142 is laminated on the back surface of the outer layer material 141. Thus, when the ranges of the outer layer material 141 providing the outer surface which are overlapped on the engaging pieces 151 and 152 are cut out, the concave portions 14a and 14b in which the engaging pieces 151 and 152 are accommodated can be simply ensured. Thus, a formational property of the fitting tube part 10 can be improved.

The terminal for the waterproof connector of the present invention is not limited to the above-described embodiment and may be suitably modified and improved.

For instance, the concave portions 14a and 14b in which the engaging pieces 151 and 152 are accommodated may be formed by press working a part of the plate material to a shape recessed to the inside of the square tube structure. In its case, the other side wall 14 does not need to be formed in the two-layered structure.

The above-mentioned embodiment is merely a typical example of the present invention, and the present invention is not limited to the embodiment. That is, the present invention can be variously modified and implemented without departing from the essential features of the present invention.

According to the terminal for a waterproof connector of the present invention, it is prevented to damage a waterproof plug and to deteriorate a waterproofing property when the terminal is inserted into the waterproof plug, and a production cost is reduced due to mitigate a working accuracy.

What is claimed is:

1. A terminal for a waterproof connector, configured to be inserted through a waterproof plug attached in the waterproof connector, the terminal comprising:
a fitting tube part, having a square tube shape, and including:
a first wall having a side extending in a longitudinal direction of the terminal;
a second wall, extended from the side of the first wall in orthogonal to the first wall, and having a side edge extending in the longitudinal direction at opposite side with respect to the first wall; and
a third wall, opposing the first wall, and having a side edge extending in the longitudinal direction and contacting the side edge of the second wall; and
a wire connection part, provided at an end of the fitting tube part in the longitudinal direction, and configured to be connected with a wire,
wherein an engaging piece is extended from the side edge of the third wall in orthogonal to the third wall so as to overlap the second wall, and
wherein the second wall is formed with a concave portion accommodating the engaging piece
the second wall includes an outer layer and an inner layer overlapping the outer layer,
the outer layer is extended from the side of the first wall, and includes a notch portion at a position corresponding to the engaging piece, and
the inner layer is extended from the side edge of the second wall in a folded manner, and includes an outer surface at the position corresponding to the engaging piece so that the concave portion is defined by the notch portion and the outer surface.

2. The terminal for waterproof connector according to claim 1, wherein
the concave portion has a depth larger than a thickness of the engaging piece so that the engaging piece is not projected from the second wall outward.

3. The terminal for waterproof connector according to claim 1, wherein
the fitting tube part and the engaging piece are made by bending a plate member.
